(19) United States
(12) Patent Application Publication
(10) Pub. No.: US 2024/0028936 A1
(43) Pub. Date: Jan. 25, 2024

(54) DEVICE AND COMPUTER-IMPLEMENTED METHOD FOR MACHINE LEARNING

(71) Applicant: Robert Bosch GmbH, Stuttgart (DE)

(72) Inventors: Christoph Zimmer, Stuttgart (DE); Matthias Bitzer, Stuttgart (DE)

(21) Appl. No.: 18/479,283

(22) Filed: Oct. 2, 2023

(30) Foreign Application Priority Data
Oct. 4, 2022 (DE) 10 2022 210 474.9

(51) Int. Cl. G06N 7/01

(52) U.S. Cl. CPC G06N 7/01

(57) ABSTRACT

A device and computer-implemented method for machine learning. A probabilistic model is provided, in particular a model that includes a probability distribution, preferably a Gaussian process or a Bayesian neural network, the model being defined as a function of at least one hyperparameter, in particular of the Gaussian process or of the Bayesian neural network. In one iteration, an instruction for a first measurement is determined and output as a function of the model. For the at least one hyperparameter an a posteriori distribution over values for the at least one hyperparameter being determined as a function of the first measurement. In another iteration, an instruction for a second measurement is determined and output as a function of the model. At least one value of the at least one hyperparameter is determined as a function of the second measurement.

### CROSS REFERENCE

The present application claims the benefit under 35 U.S.C. § 119 of German Patent Application No. DE 10 2022 210 474.9 filed on Oct. 4, 2022, which is expressly incorporated herein by reference in its entirety.

### FIELD

The present invention related to a device and a computer-implemented method for machine learning.

### BACKGROUND INFORMATION

Machine learning uses a model that is defined as a function of hyperparameters.

When determining the hyperparameters in a training with training data, in particular if the number of training data is small there is a possibility that unsuitable hyperparameters will be used.

### SUMMARY

The computer-implemented method and device according to the present invention provide a robust possibility for determining the hyperparameters, in particular for active learning.

According to an example embodiment of the present invention, the computer-implemented method for machine learning provides that a probabilistic model is provided, in particular a model including a Gaussian process or a Bayesian neural network, the model being defined as a function of at least one hyperparameter, in particular of the Gaussian process or the Bayesian neural network, where in one iteration an instruction for a first measurement is determined and output as a function of the model, and where for the at least one hyperparameter an a posteriori distribution over values for the at least one hyperparameter is determined as a function of the first measurement, and in another iteration an instruction for a second measurement is determined and output as a function of the model, and at least one value of the at least one hyperparameter is determined as a function of the second measurement.

According to an example embodiment of the present invention, preferably, it is checked whether the a posteriori distribution satisfies a condition, the at least one value for the at least one hyperparameter subsequently being determined if the a posteriori distribution satisfies the condition, or a further a posteriori distribution over values for the at least one hyperparameter subsequently being determined if the a posteriori distribution does not satisfy the condition. The condition is used to distinguish between a large uncertainty about the hyperparameters and a uncertainty about the hyperparameters that is small compared to the large uncertainty. First, using a Bayesian approach, a group of models is considered. This is especially useful when there is large uncertainty about the hyperparameters, e.g., because only a few training data have been available so far. As long as the condition is not yet satisfied, an early definition of a value is avoided. Subsequently, the value is determined by a frequentist approach. This is especially useful when there is small uncertainty about the hyperparameters. The small uncertainty arises, for example, when a sufficiently large number of training data are available.

By setting the condition, an initial determination with the Bayesian approach, which is costly in terms of the required computing resources, is replaced by a determination with the frequentist approach, which is less costly in terms of the required computing resources.

The following criteria make it possible to determine whether a Bayesian or a frequentist approach is better suited to determine the model, particularly with respect to uncertainty about the hyperparameters.

Preferably, according to an example embodiment of the present invention, the a posteriori distribution assigns values their probability measure, the condition including a first criterion that is satisfied if more than a specified percentage of probability measures of the distribution lie within an interval that is defined as a function of the largest probability measure of the distribution and includes this measure, and it being checked that the first criterion is satisfied.

Preferably, according to an example embodiment of the present invention, the condition includes a second criterion that is satisfied if a distance, in particular a Kullback-Leibler divergence, between the a posteriori distribution and a Gaussian distribution is smaller than a first threshold, and it being checked whether the second criterion is satisfied.

Preferably, according to an example embodiment of the present invention, the condition includes a third criterion that is satisfied if the a posteriori distribution is unimodal, and it being checked that the third criterion is satisfied.

Preferably, according to an example embodiment of the present invention, a preceding a posteriori distribution is determined in each of a plurality of iterations preceding the iteration, the condition including a fourth criterion that is satisfied if a difference, in particular a Kullback-Leibler divergence, between a preceding a posteriori distribution and the a posteriori distribution is smaller than a second threshold, and it being checked whether the fourth criterion is satisfied.

Preferably, according to an example embodiment of the present invention, a characteristic, in particular an entropy or a variance, of the a posteriori distribution is determined, the condition including a fifth criterion that is satisfied if the characteristic is smaller than a third threshold, and it being checked whether the fifth criterion is satisfied.

Preferably, according to an example embodiment of the present invention, in at least one iteration preceding the iteration, a preceding a posteriori distribution is determined, the a posteriori distribution satisfying the condition if the a posteriori distribution and at least one preceding a posteriori distribution satisfies the condition or at least one of the criteria.

Preferably, according to an example embodiment of the present invention, the value is determined as a function of a solution of an optimization problem that is a function of the at least one hyperparameter, in particular as a function of an optimization problem that is defined as a function of an objective function that is a function of the at least one hyperparameter, and/or that the a posteriori distribution is determined as a function of a sample drawn from a set of values for the at least one hyperparameter.

Preferably, according to an example embodiment of the present invention, the model includes the probability distribution, wherein the probability distribution is defined as a function of at least one hyperparameter, this at least one hyperparameter being determined as a function of training data that include instructions for a measurement at a device and/or the measurement, and at least one instruction or the measurement being determined as a function of a quality measure, where the quality measure includes an expected value for an entropy or a variance determined as a function of the probability distribution, or where the at least one hyperparameter is determined as a function of training data that include instructions for a simulation of a measurement executable on a device and/or the simulated measurement, and the at least one instruction or the measurement being determined as a function of a quality measure, where the quality measure includes an expected value for an entropy or a variance determined as a function of the probability distribution. The quality measure represents an information measure. The measurement is determined as a function of the information measure. This means that the method includes active learning.

In particular, for training data already present in the model, a computer-implemented machine learning method is provided in which a probabilistic model is provided, in particular a model that includes a probability distribution preferably a Gaussian process or a Bayesian neural network, the model being defined as a function of at least one hyperparameter in particular of the Gaussian process or of the Bayesian neural network, where in one iteration an a posteriori distribution over values for the at least one hyperparameter is determined for the at least one hyperparameter, and where in another iteration at least one value of the at least one hyperparameter is determined.

According to an example embodiment of the present invention, the machine learning device includes at least one processor and at least one memory, the at least one processor being designed to execute computer-readable instructions, the at least one memory being designed to store a model and computer-readable instructions upon whose execution by the at least one processor the method runs. This device has advantages that correspond to those of the method.

A computer program includes computer-readable instructions upon whose execution by a computer the method runs. This computer program has advantages that correspond to those of the method.

Further advantageous embodiments of the present invention can be learned from the following description and the figures.

### BRIEF DESCRIPTION OF THE DRAWINGS

FIG. 1 shows a schematic diagram of a device for machine learning, according to an example embodiment of the present invention.

FIG. 2 shows a flow diagram of a method for machine learning, according to an example embodiment of the present invention.

### DETAILED DESCRIPTION OF EXAMPLE EMBODIMENTS

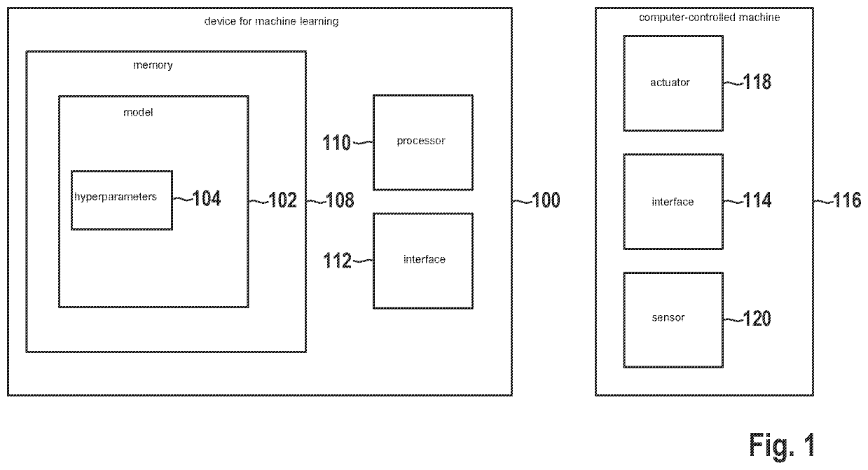

FIG. 1 schematically illustrates a device 100 for machine learning. Device 100 includes a model 102. Model 102 includes hyperparameters 104.

In the example, device 100 includes at least one memory 108 that is designed to store model 102. In the example, device 100 includes at least one processor 110 that is designed to execute computer-readable instructions.

The at least one memory 108 is designed to store computer-readable instructions upon whose execution by the at least one processor 110 a method for machine learning described below runs.

Device 100 includes an interface 112. Interface 112 is designed to communicate with an interface 114 of a device 116.

For example, device 116 is a computer-controlled machine. Device 116 is for example a robot, a vehicle, a household appliance, a tool, a manufacturing machine, a personal assistance system, or an access control system.

Device 116 includes at least one actuator 118. The at least one actuator 118 is designed to control device 116 to make a measurement as a function of instructions received by the interface 114 of the device 116. Device 116 includes at least one sensor 120. The at least one sensor 120 is designed to acquire measurements of, in particular, at least one operating variable of the device 116 or an environment of the device 116. The at least one sensor 120 is designed to communicate the measurements to the interface 112 of the device 100 via the interface 114 of the device 116. A plurality of interfaces may also be provided.

Machine learning is carried out as a function of training data D. The training data D include instructions and/or measurements that, in the example, are at least partially acquired by the at least one sensor 120 during an execution of the instructions by the at least one actuator 118. The training data D include for example scalar time series, in particular from sensor 120. The training data D include for example an operating variable of the device, e.g. a velocity or an acceleration.

The at least one actuator 118 and/or the at least one sensor 120 and/or the interface 114 can also be situated external to device 116. The at least one actuator 118 and/or the at least one sensor 120 and/or the interface 114 can be part of device 100.

Device 116 can be part of device 100. It can also be provided to determine the training data by a simulation, in particular a simulation of device 116 or at least a part of device 116.

In the active learning, model 102 is used to identify instructions upon whose execution measurements can be acquired for which the greatest possible information gain is to be expected.

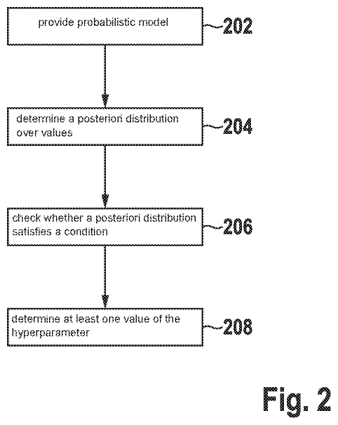

FIG. 2 shows steps of the in particular computer-implemented method.

In a step 202, a probabilistic model 102 is provided.

Model 102 includes e.g. a Gaussian process or a Bayesian neural network.

Model 102 is defined as a function of the at least one hyperparameter 104.

The at least one hyperparameter 104 is e.g. a parameter of the Gaussian process or of the Bayesian neural network.

Model 102 includes a probability distribution that is defined as a function of the at least one hyperparameter 104. The probability distribution is provided e.g. in step 202 with a specified, for example randomly determined, at least one hyperparameter 104.

In a step 204, an a posteriori distribution over values for the at least one hyperparameter 104 is determined in at least one iteration for the at least one hyperparameter 104.

In the at least one iteration, an instruction for a first measurement is determined and output as a function of model 102.

At least one value of the at least one hyperparameter 104 is determined as a function of the first measurement. The first measurement can be performed at device 116 or by simulation using a simulation model that emulates device 116.

For example, the a posteriori distribution is determined as a function of a sample drawn from a set of values for the at least one hyperparameter 104.

Using the model 102, a plurality of different instances of the at least one hyperparameter 104 determined from this a posteriori distribution are determined as a function of training data D. For a first iteration, e.g. initial training data D=D_0 are provided.

With the training data D, a set of the hyperparameters 104 is determined.

From the set of the at least one hyperparameter 104, in the example the at least one hyperparameter 104 is selected that is most suitable according to a specified metric. In the example, this is the case when the non-Bayesian way of estimating the hyperparameters 104 is carried out. Provided the Bayesian way of estimating the hyperparameters 104, an a posteriori distribution over values for the hyperparameters 104 is determined.

The training data D include for example the instructions for a measurement at device 116 and/or the measurement. In one example, the training data D include one instruction x and one measurement y each, pairwise.

The training data D are determined in the example as a function of a quality measure Info(x). The quality measure Info(x) includes an expected value for an entropy or a variance. The entropy or variance is a function of the probability distribution.

In the example, an instruction x* is determined for the measurement as a function of the quality measure Info(x). For example, the quality measure Info(x) is defined as a function of the instructions x, the instruction x*=argmaxₓ Info(x) being determined that maximizes the expected value for the entropy or the expected value for the variance.

In the example, the training data D are supplemented by the instruction x* and a measurement y, which is acquired upon controlling of device 116 with the instruction x*. The instruction x* is determined as a function of the quality measure Info(x). The at least one hyperparameter 104 is determined based on the training data D with an objective function.

In the example, the measurement y for the instruction x* is determined at device 116, and the training data is supplemented by the pair (x*,y).

It can also be provided that the at least one hyperparameter 104 is determined as a function of training data that include instructions for a simulation of a measurement executable on the device 116 and/or the simulated measurement.

In one example, the at least one hyperparameter 104 defines one or more kernel parameters γ. The probability distribution of model 102 in this case is determined using Hamiltonian Monte Carlo, HMC, to draw various kernel parameters γᵢ˜p(γ|D) from an a posteriori distribution given for the training data D p(γ|D). In this way the probability distribution of the particular model 102 is determined:

$$p ( {f}^{*} \vert {x}^{*} , D ) = \int p ( {f}^{*} \vert {x}^{*} , γ , D ) p ( γ \vert D ) d γ \approx \frac{1}{n} {\sum }_{{γ}_{i} ∼ p ( γ \vert D )} p ( {f}^{*} \vert {x}^{*} , {γ}_{i} , D )$$

The samples γᵢ from γᵢ˜p(γ|D) are determined for example by determining a first sample γ₀ from an a priori distribution p(γ) and also determining an auxiliary variable ρ₀˜N(0, M) as a function of a normal distribution N having a prespecified covariance matrix M.

The samples γᵢ are subsequently determined iteratively, e.g., in i=1:I iterations i.

In an iteration i, the samples γᵢ and ρᵢ are determined as a function of the samples γᵢ₋₁ and ρᵢ₋₁ of the previous iteration i-1, using the following differential equation:

$$\frac{d γ}{dt} = \frac{dH}{d {ρ}^{′}} , \frac{d ρ}{dt} = - \frac{dH}{d γ} \\ where H ( γ , ρ ) = log p ( D \vert γ ) + \frac{1}{2} {ρ}^{T} {M}^{- 1} ρ$$

It can be provided to use a numerical approach to solve the differential equation, for example using a Metropolis-Hastings rejection step and resetting γᵢ and ρᵢ to and ρᵢ₋₁ when a solution is rejected.

In the example, the quality measure Info(x) is determined as a function of this, where

$$p ( {f}^{*} \vert {x}^{*} , {γ}_{i} , D ) = \frac{1}{n} {\sum }_{i = 1}^{n} N ( {f}^{*} ; {μ}_{i} ( {x}^{*} ) , {σ}_{i}^{2} ( {x}^{*} ) )$$

and the entropy

H(ƒ|x,D)=∫p(ƒ|x,D)log(p(ƒ|x,D))dy

This is for example quadratically approximated by numerical integration or by a normal approximation:

$$μ ( x ) = \frac{1}{n} {\sum }_{i = 1}^{N} {μ}_{i} ( x ) \\ {σ}^{2} ( x ) = ( \frac{1}{n} {\sum }_{i = 1}^{N} {σ}_{i}^{2} ( x ) + {μ}_{i}^{2} ( x ) ) - {μ}^{2} ( x )$$

where the approximately determined entropy is H≈½ log(2πσ²(x)).

It can be provided that in at least one iteration preceding the iteration, a preceding a posteriori distribution is determined. It can be provided that in a plurality of iterations preceding the iteration, one preceding a posteriori distribution is determined in each.

It can be provided that a characteristic, in particular an entropy or a variance, of the a posteriori distribution is determined.

A step 206 is then carried out. In the example, step 206 is carried out when the condition exists in which a non-Bayesian estimation is performed. In the example, otherwise the distribution is determined.

In step 206, it is checked whether the a posteriori distribution satisfies a condition.

If the a posteriori distribution satisfies the condition, a step 208 is executed. Otherwise, step 204 is executed.

In one example, the a posteriori distribution assigns values for the at least one hyperparameter 104 their probability measure.

In one example, the condition includes a first criterion that is satisfied if more than a specified percentage of probability measures of the distribution lie within an interval.

The interval is defined e.g. as a function of the largest probability measure of the distribution. The interval includes e.g. this largest probability measure.

Alternatively, the a posteriori distribution can also assign continuous values their probability density, the condition including a first criterion that is satisfied if more than a specified percentage of the probability measure of the distribution lie within an interval defined as a function of the largest probability density of the distribution and includes this density, and it being checked whether this criterion is satisfied.

In step 206, it is optionally checked whether the first criterion is satisfied.

In one example, the condition includes a second criterion that is satisfied if a distance, in particular a Kullback-Leibler divergence, between the a posteriori distribution and a Gaussian distribution is smaller than a first threshold. In the example, the Gaussian distribution is given.

In step 206, it is optionally checked whether the second criterion is satisfied.

In one example, the condition includes a third criterion that is satisfied if the a posteriori distribution is unimodal.

In step 206, it is optionally checked whether the third criterion is satisfied.

In one example, the condition includes a fourth criterion that is satisfied if a difference, in particular a Kullback-Leibler divergence, between a preceding a posteriori distribution and the a posteriori distribution is smaller than a second threshold.

In step 206, it is optionally checked whether the fourth criterion is satisfied.

In one example, the condition includes a fifth criterion that is satisfied if the characteristic is smaller than a third threshold.

In step 206, it is optionally checked whether the fifth criterion is satisfied.

It can be provided that the a posteriori distribution satisfies the condition if the a posteriori distribution and at least one preceding a posteriori distribution satisfies the condition or at least one of the criteria.

In step 208, in at least one iteration at least one value of the at least one hyperparameter 104 is determined.

In step 208, in the example, if the condition is satisfied, the non-Bayesian estimation of the hyperparameter 104 is performed.

In the example, if the condition is not satisfied then the distribution is determined in Bayesian fashion.

In the at least one iteration, an instruction for a second measurement is determined and output as a function of model 102. In the example, when the condition is present in which a non-Bayesian estimation is performed, at least one value of the at least one hyperparameter 104 is determined as a function of the second measurement. In the example, otherwise the distribution is determined via the values of hyperparameter 104. The second measurement can be performed at the device 116 or by simulation using a simulation model that emulates device 116.

The value is determined e.g. as a function of a solution of an optimization problem that is a function of the at least one hyperparameter 104.

In one example, the value is determined as a function of the solution of an optimization problem that is defined as a function of the objective function that is a function of the at least one hyperparameter 104.

The objective function is e.g. ƒ(γ)=log p(D|γ). The information criterion Info(x) is used for example in each iteration to select a measurement configuration x. The objective function ƒ(γ) is maximized between iterations; in the example the objective function ƒ(γ) is maximized between the iterations only if the condition is present in which a non-Bayesian estimation is to be performed. Otherwise, a Bayesian estimation is performed.

The at least one hyperparameter 104 is determined using the model 102 for the value of the hyperparameter 104 as a function of the training data D with the objective function.

The training data D include the instructions x*. In the example, the instructions x* are determined as a function of the quality measure Info(x).

This means that the quality measure Info(x) is determined as a function of the at least one hyperparameter 104. At least one instruction or the measurement is determined as a function of the quality measure Info(x). In this way, active learning is implemented.

It can also be provided that the at least one hyperparameter 104 is determined as a function of the training data that include instructions for the simulation of the measurement that is executable at the device 116 and/or the simulated measurement.

What is claimed is:

1. A computer-implemented method for machine learning, the method comprising the following steps:
providing a probabilistic model, the probabilistic model including a probability distribution including a Gaussian process or a Bayesian neural network, the probabilistic model being defined as a function of at least one hyperparameter of the Gaussian process or of the Bayesian neural network;
in one iteration, determining, as a function of the probabilistic model, an instruction for a first measurement, and outputting the instruction for the first measurement;
for the at least one hyperparameter, determining an a posteriori distribution over values for the at least one hyperparameter as a function of the first measurement;
in another iteration, determining an instruction for a second measurement as a function of the probabilistic model, and outputting the instruction for the second measurement; and
determining at least one value of the at least one hyperparameter as a function of the second measurement.

2. The method as recited in claim 1, further comprising:
checking whether the a posteriori distribution satisfies a condition, the at least one value for the at least one hyperparameter subsequently being determined based on the a posteriori distribution satisfying the condition, or a further a posteriori distribution over values for the at least one hyperparameter subsequently being determined based on the a posteriori distribution not satisfying the condition.

3. The method as recited in claim 2, wherein the a posteriori distribution assigns values their probability measure, the condition including a first criterion that is satisfied when more than a specified percentage of probability measures of the distribution lie within an interval that is defined as a function of a largest probability measure of the distribution and includes the measure, and it being checked whether the first criterion is satisfied.

4. The method as recited in claim 2, wherein the condition includes a second criterion that is satisfied when a distance including a Kullback-Leibler divergence, between the a posteriori distribution and a Gaussian distribution is smaller than a first threshold, and it being checked whether the second criterion is satisfied.

5. The method as recited in claim 2, wherein the condition includes a third criterion that is satisfied when the a posteriori distribution is unimodal, and it being checked whether the third criterion is satisfied.

6. The method as recited in claim 2, wherein a preceding a posteriori distribution is determined in each of a plurality of iterations preceding the iteration, the condition including a fourth criterion that is satisfied when a difference including a Kullback-Leibler divergence, between a preceding a posteriori distribution and the a posteriori distribution is smaller than a second threshold, and it being checked whether the fourth criterion is satisfied.

7. The method as recited in claim 2, wherein a characteristic, including an entropy or a variance, of the a posteriori distribution is determined, the condition including a fifth criterion that is satisfied when the characteristic is smaller than a third threshold, and it being checked whether the fifth criterion is satisfied.

8. The method as recited in claim 3, wherein in at least one iteration preceding the iteration, a preceding a posteriori distribution is determined, the a posteriori distribution satisfying the condition when the a posteriori distribution and the at least one preceding a posteriori distribution satisfy the condition or the first criterion.

9. The method as recited in claim 1, wherein the value is determined as a function of a solution of an optimization problem that is a function of the at least one hyperparameter, the value being determined as a function of the solution of the optimization problem that is defined as a function of an objective function that is a function of the at least one hyperparameter, and/or the a posteriori distribution is determined as a function of a sample drawn from a set of values for the at least one hyperparameter.

10. The method as recited in claim 1, wherein the probabilistic model includes the probability distribution, the probability distribution being defined as a function of at least one hyperparameter, the at least one hyperparameter being determined: i) as a function of training data that include instructions for a measurement at a device and/or the measurement, and at least one instruction or the measurement being determined as a function of a quality measure, the quality measure including an expected value for an entropy or a variance that is determined as a function of the probability distribution, or ii) as a function of training data that include instructions for a simulation of a measurement that is executable on a device and/or the simulated measurement, and at least one instruction or the measurement being determined as a function of a quality measure, the quality measure including an expected value for an entropy or a variance that is determined as a function of the probability distribution.

11. The method as recited in claim 1, wherein, in one iteration for the at least one hyperparameter, an a posteriori distribution over values for the at least one hyperparameter is determined, at least one value of the at least one hyperparameter being determined in another iteration.

12. A device for machine learning, comprising:
at least one processor; and
at least one memory;
wherein the at least one processor is configured to execute computer-readable instructions, the at least one memory being configured to store a model and computer-readable instructions upon whose execution by the at least one processor, the at least one processor performs:
providing the model, the model being a probabilistic model, the probabilistic model including a probability distribution including a Gaussian process or a Bayesian neural network, the probabilistic model being defined as a function of at least one hyperparameter of the Gaussian process or of the Bayesian neural network;
in one iteration, determining, as a function of the probabilistic model, an instruction for a first measurement and outputting the instruction for the first measurement;
for the at least one hyperparameter, determining an a posteriori distribution over values for the at least one hyperparameter as a function of the first measurement;
in another iteration, determining an instruction for a second measurement as a function of the probabilistic model, and outputting the instruction for the second measurement; and
determining at least one value of the at least one hyperparameter as a function of the second measurement.

13. A non-transitory computer readable medium on which is stored a computer program including computer-readable instructions for machine learning, the instructions, when executed by a computer, causes the computer to perform the following steps:
providing a probabilistic model, the probabilistic model including a probability distribution including a Gaussian process or a Bayesian neural network, the probabilistic model being defined as a function of at least one hyperparameter of the Gaussian process or of the Bayesian neural network;
in one iteration, determining, as a function of the probabilistic model, an instruction for a first measurement and outputting the instruction for the first measurement;
for the at least one hyperparameter, determining an a posteriori distribution over values for the at least one hyperparameter as a function of the first measurement;
in another iteration, determining an instruction for a second measurement as a function of the probabilistic model, and outputting the instruction for the second measurement; and
determining at least one value of the at least one hyperparameter as a function of the second measurement.
